(19) United States
(12) Patent Application Publication
(10) Pub. No.: US 2026/0027466 A1
(43) Pub. Date: Jan. 29, 2026

(54) METHODS AND MOBILE DEVICES

(71) Applicant: Sony Interactive Entertainment Inc., Tokyo (JP)

(72) Inventors: Jun Yen Leung, London (GB); Maurizio Cerrato, London (GB); Lawrence Martin Green, London (GB); Maria Chiara Monti, London (GB); Patrick John Connor, London (GB); Rajeev Gupta, London (GB)

(73) Assignee: Sony Interactive Entertainment Inc., Tokyo (JP)

(21) Appl. No.: 19/265,045

(22) Filed: Jul. 10, 2025

(30) Foreign Application Priority Data
Jul. 29, 2024 (GB) 2411098.3

(51) Int. Cl. A63F 13/5375; A63F 13/213; A63F 13/216; A63F 13/235; A63F 13/285; A63F 13/327; A63F 13/54; A63F 13/65

(52) U.S. Cl. CPC A63F 13/5375; A63F 13/213; A63F 13/216; A63F 13/235; A63F 13/285; A63F 13/327; A63F 13/54; A63F 13/65; A63F 2300/8082

(57) ABSTRACT

A method performed by a first mobile device for guiding travel of a first user of the first mobile device provided. The method includes wirelessly communicating with a second mobile device of a second user. The method includes determining, based on the communication with the second mobile device, location information of the second mobile device. The method includes determining, based on the location information of the second mobile device, a recommended travel path for the first user. The method includes providing an indication of the recommended travel path to the first user.

### TECHNICAL FIELD

The present disclosure relates to methods and mobile devices for guiding travel of users of the mobile devices.

### BACKGROUND

Mobile devices enable users to perform computations “on-the-go”. For example, mobile devices may be used to communicate with other mobile devices or play games, such as augmented reality (AR) games. In recent times, the popularity of mobile devices has grown with a large proportion of the population regularly using mobile devices. In public places, for example, there may be a large number of people using mobile devices at any one time. Since mobile devices require user engagement (e.g. the user may need to look at a screen of the device while operating it), users of mobile devices in public places may not always be attentive to their surroundings. This may cause users of mobile devices to reach their destination in efficiently by travelling an unnecessarily long route because they took a wrong turn, or even to bump into each other or other obstacles because they are focussing on the mobile device and not on where they are going. Furthermore, as the number of mobile users increases, the risk of users inefficiently reaching their destination and/or colliding with obstacles in their surroundings is increased.

The present application aims to mitigate at least some of the-above issues.

### SUMMARY

The present disclosure is defined by the appended claims.

### BRIEF DESCRIPTION OF THE DRAWINGS

To assist understanding of the present disclosure and to show how embodiments may be put into effect, reference is made by way of example to the accompanying drawings in which:

FIG. 1 schematically illustrates an example of an entertainment system;

FIG. 2 schematically illustrates an example of a Head Mounted Display (HMD);

FIG. 3 schematically illustrates an example of mobile devices in a remote-play set up;

FIG. 4 is a flow diagram illustrating a method for guiding travel of a user of a mobile device in accordance with example embodiments;

FIG. 5 is a flow diagram illustrating a method for guiding travel of a user of a mobile device in accordance with example embodiments;

FIG. 6 schematically illustrates a recommended travel path of a user in accordance with example embodiments;

FIG. 7 schematically illustrates a recommended travel path of a user in accordance with example embodiments;

FIG. 8 schematically illustrates a recommended travel path of a user in accordance with example embodiments;

FIG. 9 schematically illustrates a mobile device in accordance with example embodiments.

### DETAILED DESCRIPTION

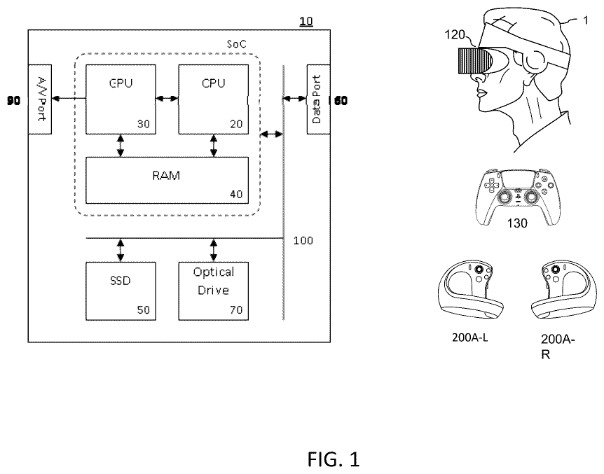

Referring to FIG. 1, an example of an entertainment system 10 is a computer or console.

The entertainment system 10 comprises a central processor or CPU 20. The entertainment system also comprises a graphical processing unit or GPU 30, and RAM 40. Two or more of the CPU, GPU, and RAM may be integrated as a system on a chip (SoC). Further storage may be provided by a disk 50, either as an external or internal hard drive, or as an external solid state drive, or an internal solid state drive.

The entertainment system 10 may transmit or receive data via one or more data ports 60, such as a USB port, Ethernet® port, Wi-Fi@ port, Bluetooth® port or similar, as appropriate. It may also optionally receive data via an optical drive 70. Audio/visual outputs from the entertainment device are typically provided through one or more A/V ports 90 or one or more of the data ports 60. Where components are not integrated, they may be connected as appropriate either by a dedicated data link or via a bus 100.

An example of a device for displaying images output by the entertainment system is a head mounted display ‘HMD’ 120, worn by a user 1.

Interaction with the system is typically provided using one or more handheld controllers 13, and/or one or more VR controllers (200A-L, R) in the case of the HMD 120. The controllers 13, 200A-L, R may each be referred to as video game controllers. Such controllers may alternatively or in addition be integrated into the entertainment device, and/or virtualised on-screen, particularly in the case of a portable form of such an entertainment device.

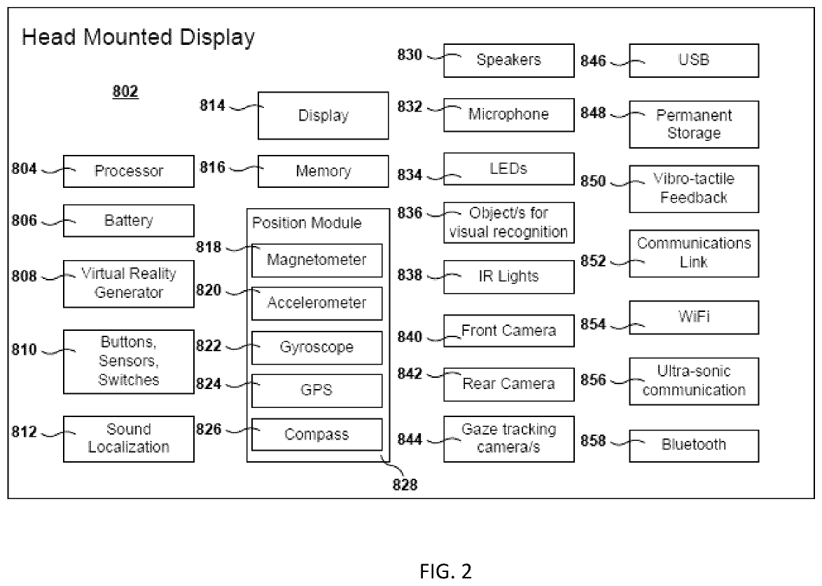

FIG. 2 illustrates the architecture of a HMD device (such as HDM 120). The HMD is typically a computing device and may include modules usually found on a computing device, such as one or more of a processor 804, memory 816 (RAM, ROM, etc.), one or more batteries 806 or other power sources, and permanent storage 848 (such as a solid state disk).

One or more communication modules can allow the HMD to exchange information with other portable devices, other computers, other HMDs, servers, etc. Communication modules can include a Universal Serial Bus (USB) connector 846, a communications link 852 (such as Ethernet®), ultrasonic or infrared communication 856, Bluetooth® 858, and Wi-Fi® 854.

A user interface can include one or more modules for input and output. The input modules can include input buttons (e.g. a power button), sensors and switches 810, a microphone 832, a touch sensitive screen (not shown, that may be used to configure or initialize the HMD), one or more front cameras 840, one or more rear cameras 842, one or more gaze tracking cameras 844. Other input/output devices, such as a keyboard or a mouse, can also be connected to the portable device via communications link, such as USB or Bluetooth®.

The output modules can include the display 814 for rendering images in front of the user's eyes. Some embodiments may include one display, two displays (one for each eye), micro projectors, or other display technologies. The user typically sees the or each display through left and right optical assemblies 815 L,R. Other output modules can include Light-Emitting Diodes (LED) 834 (which may also be used for visual tracking of the HMD), vibro-tactile feedback 850, speakers 830, and a sound localization module 812, which performs sound localization for sounds to be delivered to speakers or headphones. Other output devices, such as headphones, can also connect to the HMD via the communication modules, be permanently attached to the HMD, or integral to it.

One or more elements that may be included to facilitate motion tracking include LEDs 834, one or more objects for visual recognition 836, and infrared lights 838. Alternatively or in addition, the one or more front or rear cameras may facilitate motion tracking based on image motion.

Information from one or more different modules can be used by the position module 828 to calculate the position of the HMD. These modules can include a magnetometer 818, an accelerometer 820, a gyroscope 822, a Global Positioning System (GPS) module 824, and a compass 826. Alternatively or in addition, the position module can analyse image data captured with one or more of the cameras to calculate the position. Further yet, optionally the position module can perform tests to determine the position of the portable device or the position of other devices in the vicinity, such as a Wi-Fi@ ping test or ultrasound tests.

A virtual reality generator 808 then outputs one or more images corresponding to a virtual or augmented reality environment or elements thereof, using the position calculated by the position module. The virtual reality generator 808 may cooperate with other computing devices (e.g. PS5® or other game console, Internet server, etc.) to generate images for the display module 814. The remote devices may send screen updates or instructions for creating game objects on the screen.

Hence the virtual reality generator 808 may be responsible for none, some, or all of the generation of one or more images then presented to the user, and/or may be responsible for any shifting of some or all of one or both images in response to inter-frame motion of the user (e.g. so-called reprojection).

It should be appreciated that the embodiment illustrated in FIG. 2 is an exemplary implementation of an HMD, and other embodiments may utilize different modules, a subset of the modules, or assign related tasks to different modules. The embodiment illustrated in FIG. 2 should therefore not be interpreted to be exclusive or limiting, but rather exemplary or illustrative.

### Mobile Gaming

### Remote Play

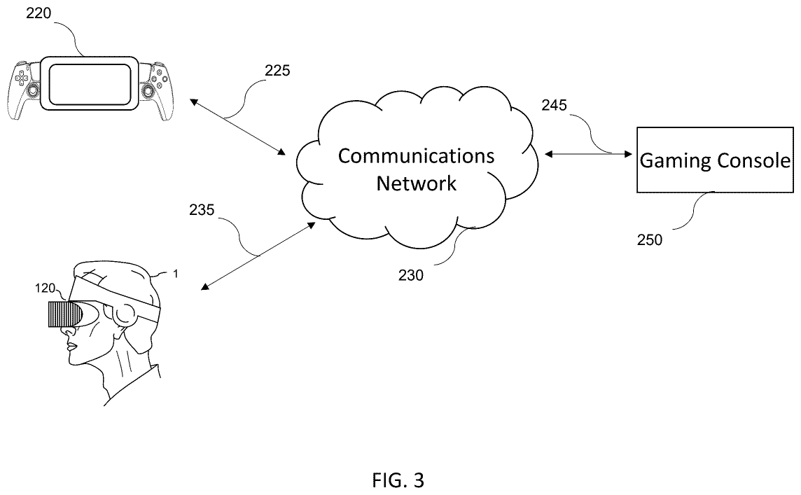

FIG. 3 schematically illustrates an example of a remote play gaming set up. In particular, a plurality of mobile devices including a HMD 120 and a handheld mobile device 220 are connected to a gaming console 250 via a communications network 230 (such as a 5G network). In particular, the handheld mobile device 220 is connected to the communications network 230 via a wireless connection 225 (such as a radio connection) and the HMD 120 is connected to the communications network 230 via a wireless connection 235 (such as a radio connection). The communications network 230 is connected to a gaming console 250 (such as entertainment system 10) via one or more wired and/or wireless connections 245 (such as a Wi-Fi connection). Although not shown in FIG. 3, the gaming console 250 may run a video game locally on the gaming console 250. For example, the gaming console 250 may run a game application stored in a memory of the gaming console 250 or may run a game stored on an external storage device which is readable by the gaming console 250 (such as a Blu-Ray@ disc). In either case, in remote play, the mobile devices 120, 220 stream the video game from the gaming console 250 via the connections 225, 235, 245. As will be appreciated, remote play allows for increased flexibility in gaming while leveraging the processing power of the gaming console 250. The mobile devices 120, 220 may not have the hardware capabilities to run the video game run by the gaming console 250 in the above example. The gaming console itself may be part of a cloud gaming server, either as a physical device or a virtual machine, or a mixture of the two.

As alternatives to remote play, mobile devices 120, 220 may run video game applications locally on the mobile devices 120, 220 (i.e. run video game applications stored in the memory of the mobile device or stored in a removable memory of the mobile device such as a Blu-Ray disc or storage card) or stream the video game from a server (e.g. playing an online game on the mobile device).

### Mobile Augmented Reality (AR)

As will be appreciated by a person skilled in the art, mobile augmented reality (AR) is the use of AR on a mobile device. In particular, a mobile device configured with AR is able to superimpose computer-generated images on a view of the user's environment. For example, a mobile AR headset, which is an example of a mobile device, may be configured to superimpose computer-generated images onto a user's view through the headset. In another example, a hand-held mobile device (such as a cellular phone, portable console, or remote view screen) may superimpose computer-generated images on a user's view of the environment through a camera of the handheld mobile device. Since the user is viewing computer-generated images superimposed on the user's view of the environment, the user's view of the environment may be at least partially obscured. This may make it particularly difficult for a user of mobile AR to successfully navigate in public places with many obstacles including other mobile AR users.

In view of the above, there is provided methods and mobile devices for guiding travel of a user of a mobile device.

### Guiding Travel Based on Communication with a Second Mobile Device

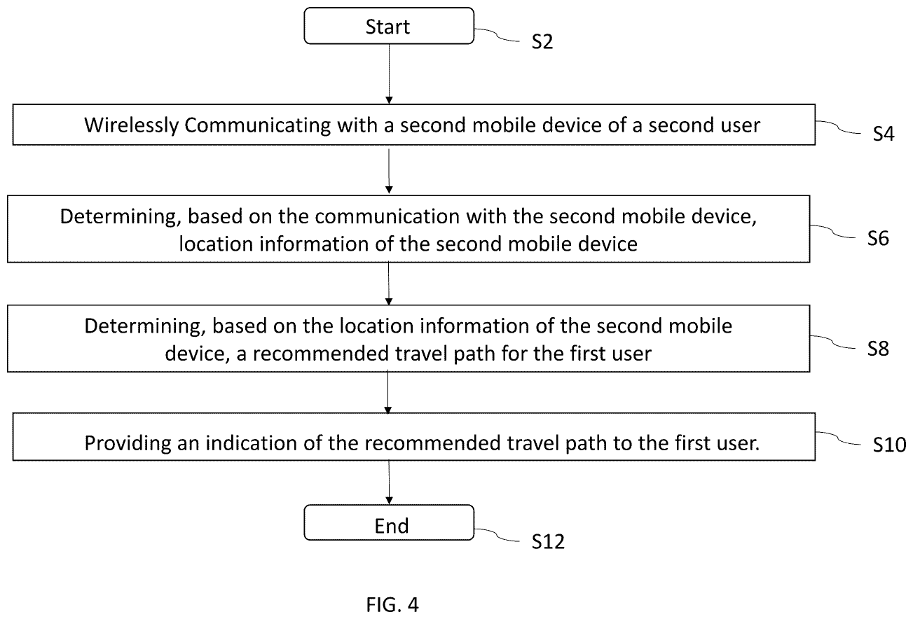

According to a first aspect, there is provided a method performed by a first mobile device for guiding travel of a first user of the first mobile device as illustrated in FIG. 4.

The method starts in step S2.

In step S4, the method comprises wirelessly communicating with a second mobile device of a second user.

In step S6, the method comprises determining, based on the communication with the second mobile device, location information of the second mobile device.

In step S8, the method comprises determining, based on the location information of the second mobile device, a recommended travel path for the first user.

In step S10, the method comprises providing an indication of the recommended travel path to the first user.

The method ends in step S12.

In some embodiments, the step of wirelessly communicating with the second mobile device comprises wirelessly communicating with the second mobile device using radio signals. For example, the first mobile device may communicate using radio signals via Bluetooth® and/or WiFi Direct®. In some embodiments, the step of wirelessly communicating with the second mobile device further comprises wirelessly communicating with the second mobile device using ultrasound signals. Therefore, in some embodiments, the step of wirelessly communicating with the second mobile device comprises communicating with one selected from the list consisting of:
(i) Bluetooth and Ultrasound;
(ii) WiFi Direct and Ultrasound; and
(iii) Bluetooth and WiFi Direct and Ultrasound.

It will be appreciated that whilst the present description refers to mobile devices communicating with each other, this may not necessitate an ongoing link or specific two-way communication process. For example, each device may use a Bluetooth advertising beacon to unilaterally transmit data relevant to the methods and techniques herein, for reception by any other participating device nearby. Optionally a similar beacon may use ultrasound. Hence each participating device may operate independently within a radio (and optionally ultrasound) environment created by their respective broadcasts.

In some embodiments, the step of determining the location information of the second mobile device based on the communication with the second mobile device comprises determining a distance between the first mobile device and the second mobile device based on the communication with the second mobile device, and determining a direction in which the second user of the second mobile device is moving based on the communication with the second mobile device. In some embodiments, the second mobile device indicates its location to the first mobile device during the wireless communication (for example, as GPS co-ordinates). In some embodiments, the second mobile device may also indicate the direction in which the second mobile device is moving during the wireless communication. In some embodiments, the first mobile device uses one or more signals (for example, Bluetooth and/or WiFi and, optionally, ultrasound) transmitted between the first mobile device and the second mobile devices to calculate the distance to the second mobile device. For example, the first mobile device may use triangulation based on one or more signals transmitted to the second mobile device, and one or more signals received from the second mobile device, to calculate the distance to the second mobile device.

In some embodiments, a distance may be calculated using radio signals (Bluetooth and/or WiFi) and another distance may be calculated using Ultrasound signals, and the calculated distances are averaged to determine the distance between the first mobile device and the second mobile device. In another example, the first mobile device may calculate the distance based on the received signal strength of one or more radio signals (such as Bluetooth and/or WiFi signals) from the second mobile device. In such embodiments, the first mobile device may refine the calculation of the distance based on one or more time-of-flight calculations using one or more ultrasound signals transmitted to the second mobile device and one or more ultrasound signals received from the second mobile device. In particular, refining of the calculated distance may involve removing false positives. In other words, if a distance is determined using radio signals, the ultrasound signals can be used to verify that the distance determined using the radio signals is between the correct two objects. For example, ultrasound has difficulty penetrating obstacles and is sensitive to reflections off objects, thereby creating multipath effects. Accordingly, any time of flight measurement using ultrasound signals is an over-estimate of the truth. Accordingly, the distance determined using the radio signals can be compared with the distance determined using the ultrasound signals and, if the distance determined using the radio signals is lower, then it is assumed to be an accurate measurement of distance. However, if the distance determined from the radio signals is higher, then this is likely the result of reflections and therefore the distance measurement should be disregarded.

Accordingly, the calculation of the distance using ultrasound in addition to Bluetooth and/or WiFi (rather than Bluetooth and/or WiFi) leads to an increased accuracy in the calculated distance.

In some embodiments, the step of wirelessly communicating with the second mobile device comprises receiving, from the second mobile device, an indication of a recommended travel path for the second user. In such embodiments, the recommended travel path for the first user is determined based at least in part on the indication of the recommended travel path for the second user. Accordingly, the recommended travel path for the first user may be determined taking into account the recommended travel path for the second user. Therefore, the recommended travel path for the first user may be determined so that the first and second user do not collide, or so that the first and second user converge on a common point at different times (such as a narrow exit), for example.

In some embodiments, the location information of the second mobile device is determined based on the communication with the second mobile device and without referring to images. Such embodiments are particularly energy efficient and require relatively low battery power.

However, in some embodiments, the location information of the second mobile device is determined based on the communication with the second mobile device and based on one or more images of an environment comprising the second mobile device captured by the first mobile device. Such embodiments allow for increased accuracy in determining the location information of the second mobile device. The one or more images may be a video, for example.

In some embodiments, the first mobile device determines a distance between the first mobile device and the second mobile device based on the communication between the first mobile device and the second mobile device (as explained above) and determines whether or not to capture one or more images of the environment based on the determined distance. For example, if the determined distance is below a pre-defined threshold, the first mobile device may capture one or more images of the environment comprising the second mobile device and use the one or more images to obtain a more accurate distance to the second mobile device based on the one or more images.

In some embodiments, the step of determining the recommended travel path for the first user comprises determining, based on the one or more images, location information of one or more features in the environment other than the second user, and determining the recommended travel path for the first user based on the location information of the second user and the location information of the one or more other features.

The features may be obstacles in the environment (e.g. obstructions such as trees, the second user, other pedestrians, lamp-posts, no-entry signs or other street furniture). The features may include preferred and non-preferred routes. A preferred route may be along a pavement while a non-preferred route may be along grass, for example.

In some embodiments, the recommended travel path for the first user guides the first user to avoid a collision between the first user and the second user. In some embodiments, the recommended travel path for the first user may also guide the user to avoid the obstacles in the environment. In some embodiments, the recommend travel path guides the first user to reach the same location as the second user at a different time.

In some embodiments, the method comprises generating, based on the one or more images, a representation of at least part of the environment. In such embodiments, the step of determining the location information of the second mobile device comprises predicting a location of the second mobile device at a future time based on the communication with the second mobile device and based on the generated representation of at least part of the environment. In such embodiments, the step of determining the location information of the one or more other features comprises predicting a location of the one or more other features at the future time based on the generated representation of at least part of the environment.

The generation of the representation of at least part of the environment may comprise generating a 3D reconstruction based on the one or more images. The 3D reconstruction may be regarded as a “virtual environment”.

In some embodiments, a 3D reconstruction may be approximated based on the one or more images by comparing the relative sizes of features in the one or more images with the sizes of other features with known sizes and distances from the first mobile device in the one or more images. Such features may include walls, heads or other object in the environment.

In some embodiments, the 3D reconstruction may be generated based on the one or more images by applying a Simultaneous Localisation and Mapping (SLAM) algorithm to the one or more images. In some embodiments, the first mobile device uses the 3D reconstruction to produce depth information of the at least part of the environment. The depth information may be a per-pixel depth buffer of the at least part of the environment. In some embodiments, where the one or more captured images are RGB images, the first mobile device may construct one or more 4-channel image frames based on the one or more RGB images and the per-pixel depth buffer of the at least part of the environment. In some embodiments, the predicting the location of one or more features in the environment at a future time based on the generated representation of at least part of the environment comprises feeding a past N 4-channel image frames into an artificial intelligence algorithm (such as a convolutional neural network) which is then used to predict the next M 4-channel image frames. The M 4-channel image frames output by the artificial intelligence algorithm indicate the predicted locations of the features in the environment. In some embodiments, the determining the recommended travel path for the first user based on the predicted location of the one or more features may comprise feeding the predicted M 4-channel image frames into a path-finding algorithm (such as Dijkstra's algorithm) to produce a set of anchor points in 3D space which form the recommended travel path for the first user. A line (such as a smooth Bezier curve) may be drawn between the anchor points to represent the recommended travel path. In some examples, where the features are obstacles, the line connecting the anchor points may be such that it describes a path which avoids collision between the first user and the obstacles.

The artificial intelligence algorithm may be trained based on training data. The training data may comprise one or more images of previous environments with varying densities of features (e.g. varying densities of crowds of people). Accordingly, a stream of N+M frames may be divided (for example, in half) to form an input set of frames to the artificial intelligence algorithm and to form a ground truth set of frames which are the expected ground truth for the expected output of the artificial intelligence algorithm.

In some embodiments, the second mobile device may transmit an indication of a recommended travel path for the second user to the first mobile device. In such embodiments, the first mobile device may adjust the recommended travel path for the first user based on the indication of the recommended travel path for the second user. For example, the recommended travel path for the first user may have been determined based on the predicted location of one or more features-for example, the recommended path for the first user may guide the first user to avoid a tree, or lamppost or other street furniture. However, after receiving the indication of the recommended travel path for the second user, the first mobile device may adjust the recommended travel path for the first user to also avoid colliding with the second user, or to converge with the second user to arrive at a common point at different times, for example.

In some embodiments, the step of determining the recommended travel path for the first user comprises identifying, based on the one or more images, one or more gaps between the second user and the one or more other features, and routing the recommended travel path for the first user through one or more of the identified gaps. Therefore, the collisions between the first user and other features (such as obstacles) can be avoided.

In some embodiments, the first mobile device classifies the one or more other features as static or dynamic features based on the one or more images. This helps the first mobile device to determine whether it should predict a trajectory of features to predict a future location, or whether the feature will not move in the future.

In some embodiments, the step of providing the indication of the recommended travel path to the first user comprises performing one or more operations selected from the list consisting of:
i) vibrating a part of the first mobile device to indicate the recommended travel path. For example, if the recommend path is to the left of the first user, vibrating a left part of the first mobile device;
ii) emitting a sound from the first mobile device to indicate the recommended travel path.

For example, emitting a sound indicating a subsequent direction in which to move e.g. “TURN RIGHT”. In another example, the volume of sound on an application run by the first mobile device may indicate a direction in which to move to follow the recommended travel path. For example, if the recommended travel path is to the left of the first user, the sound emitted on speakers on a left side of the first mobile device, or through a left headphone plugged into the device, may be louder than the sound emitted from speakers on a right side of the first mobile device, or through a right headphone. In this way, the first mobile device can run the application uninterrupted whilst still guiding the user along the recommended path; and
(i) iii) displaying the indication of the recommended travel path on the first mobile device. For example, an arrow may be displayed on the first mobile device indicating a direction in which to move to follow the recommended travel path;
(ii) (iv) adjusting a direction of spatial audio towards a side of the device to indicate the recommended travel path. For example, if the recommend path is to the left of the first user, adjusting the direction of the spatial audio to be directed towards the left.

In some embodiments, where the indication of the recommended travel for the first user is displayed on the first mobile device, the recommended travel path is displayed on the first mobile device as a line connecting the set of anchor points previously mentioned. In some embodiments, the line is displayed relative to representation of at least part of the environment (e.g. relative to a virtual environment). For example, where the first mobile devices is an AR headset, or handheld mobile device with AR implemented, the view through the AR headset or handheld mobile device may show the line representing the recommended travel path superimposed on a virtual environment viewable through the AR headset or handheld mobile device. Accordingly, the first user can play an AR game utilising the virtual environment whilst simultaneously being guided along the recommended travel path to, for example, avoid obstacles in the environment such as the second user or street furniture.

In some embodiments, the first mobile device is a handheld mobile device (such as handheld mobile device 220) held by the first user such a cellular phone, remote view screen, or portable games console, or the like. In some embodiments, the first mobile device is an AR or VR headset worn by the first user (such as HMD 120), optionally operating in conjunction with a mobile phone or console.

In some embodiments, the step of determining the recommended travel path for the first user comprises defining a minimum travel path length for the recommended travel path for the first user based on one or more conditions. The conditions may be pre-defined by the first user, for example. In other words, the first mobile device determines the recommended path for the first user so as not to exceed the minimum path length.

In some embodiments, the step of wirelessly communicating with the second mobile device of the second user comprises receiving priority determination information from the second mobile device. In such embodiments, the method comprises determining, based on the priority determination information, that the recommended travel path for the first user has a higher priority than a recommended travel path for the second user, and transmitting a priority indication to the second mobile device indicating that that the recommended travel path for the first user has a higher priority than the recommended travel path for the second user. The priority indication indicates to the second mobile device to adjust the recommended travel path for the second user. The priority determination information comprises one or more selected from the list consisting of:
i) an indication of the speed of movement of the second mobile device; and
ii) an indication of a number of features that the recommended travel path for the second user has been routed to avoid.

By using priority determination information, the first mobile device can determine whether to give priority to the recommended travel path for the first user over the recommended travel path for the second user. For example, if the recommended travel path for the first and second user cause a collision between the first and second user, then the recommended travel path for the first user is re-routed if the recommended travel path for the second user has a higher priority. The recommended travel path for the second user may have a higher (or lower) priority than the recommended travel path for the first user if, for example, it has been routed to avoid a large number of features (e.g. obstacles) than the recommended path for the first user and/or the second mobile device has is moving at a greater speed than the first mobile device. Other criteria for prioritisation may relate for example to the relative demographics of the users, for example prioritising children and the elderly over other adults for at least some path recommendations.

### Guiding Travel Based on Images of the Environment

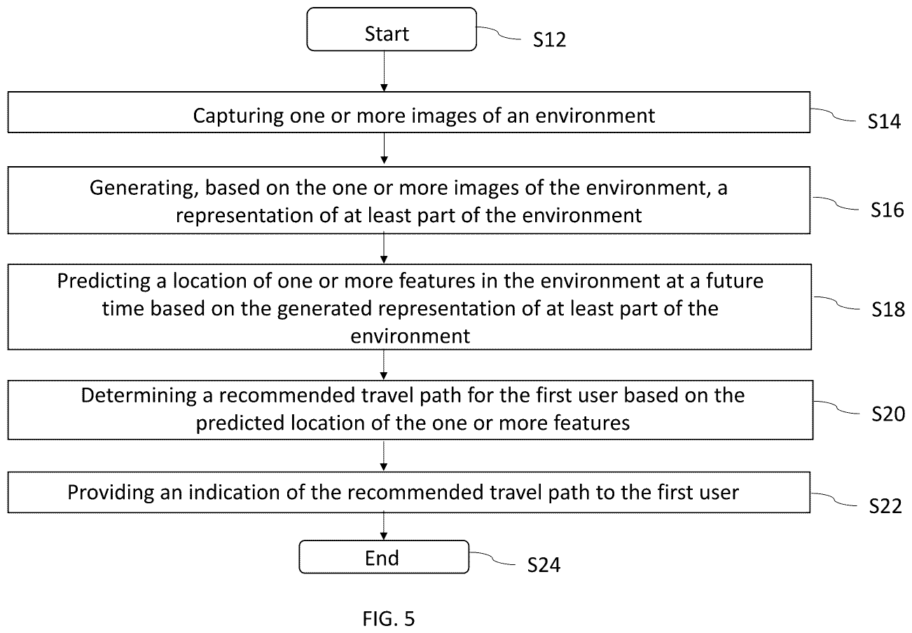

According to a second aspect, there is provided a method performed by a first mobile device for guiding travel of a first user of the first mobile device as illustrated in FIG. 5.

The method starts in step S12.

In step S14, the method comprises capturing one or more images of an environment.

In step S16, the method comprises generating, based on the one or more images of the environment, a representation of at least part of the environment.

In step S18, the method comprises predicting a location of one or more features in the environment at a future time based on the generated representation of at least part of the environment.

In step S20, the method comprises determining a recommended travel path for the first user based on the predicted location of the one or more features.

In step S22, the method comprises providing an indication of the recommended travel path to the first user.

The method ends in step S24.

By using one or more images captured by the first mobile device, an accurate representation of at least part of the environment may be generated using one or more images captured by the first mobile device. Accordingly, the location of the features at the future time can be accurately predicted. This means that a more accurate recommend travel path can be determined. As explained previously, the features may be obstacles, for example. Therefore, in some embodiments, the recommend travel path can be determined to accurately avoid the one or more obstacles to avoid collision with the first user.

In some embodiments, the one or more features include a second user of a second mobile device. In the method according to the second aspect, it is not necessary for the first mobile device to communicate with the second mobile device (or passively receive broadcast advertisements or the like from it) in order for the first mobile device to predict the location of the second mobile device at a future time, because the first mobile device can predict the location based on the generated representation of that least part of the environment.

However, in some embodiments, the second mobile device may transmit an indication of a recommended travel path for the second user to the first mobile device. In such embodiments, the first mobile device may adjust the recommended travel path for the first user based on the indication of the recommended travel path for the second user. For example, the recommended travel path for the first user may have been determined based on the predicted location of one or more features—for example, the recommended path for the first user may guide the first user to avoid a tree, or lamppost or other street furniture. However, after receiving the indication of the recommended travel path for the second user, the first mobile device may adjust the recommended travel path for the first user to also avoid colliding with the second user, or to converge with the second user to arrive at a common point at different times, for example.

The generation of the representation of at least part of the environment may comprise generating a 3D reconstruction based on the one or more images. In some embodiments, a 3D reconstruction may be approximated based on the one or more images by comparing the relative sizes of features in the one or more images with the sizes of other features with known sizes and distances from the first mobile device in the one or more images. Such features may include walls, heads or other object in the environment.

In some embodiments, the 3D reconstruction may be generated based on the one or more images by applying a Simultaneous, Localisation and Mapping (SLAM) algorithm to the one or more images. In some embodiments, the first mobile device uses the 3D reconstruction to produce depth information of the at least part of the environment. The depth information may be a per-pixel depth buffer of the at least part of the environment. In some embodiments, where the one or more captured images are RGB images, the first mobile device may construct one or more 4-channel image frames based on the one or more RGB images and the per-pixel depth buffer of the at least part of the environment. In some embodiments, the predicting the location of one or more features in the environment at a future time based on the generated representation of at least part of the environment comprises feeding a past N 4-channel image frames into an artificial intelligence algorithm (such as a convolutional neural network) which is then used to predict the next M 4-channel image frames. The M 4-channel image frames output by the artificial intelligence algorithm indicate the predicted locations of the features in the environment. In some embodiments, the determining the recommended travel path for the first user based on the predicted location of the one or more features may comprise feeding the predicted M 4-channel image frames into a path-finding algorithm (such as Dijkstra's algorithm) to produce a set of anchor points in 3D space which form the recommended travel path for the first user. A line (such as a smooth Bezier curve) may be drawn between the anchor points to represent the recommended travel path. In some examples, where the features are obstacles, the line connecting the anchor points may be such that it describes a path which avoids collision between the first user and the obstacles.

The artificial intelligence algorithm may be trained based on training data. The training data may comprise one or more images of previous environments with varying densities of features (e.g. varying densities of crowds of people). Accordingly, a stream of N+M frames may be divided (for example, in half) to form an input set of frames to the artificial intelligence algorithm and to form a ground truth set of frames which are the expected ground truth for the expected output of the artificial intelligence algorithm.

In some embodiments, the one or more images are a video captured by the first mobile device.

In some embodiments, the step of providing the indication of the recommended travel for the first user comprises displaying the indication of the recommended travel path on the first mobile device. For example, the recommended travel path may be displayed on the first mobile device as a line connecting the set of anchor points previously mentioned. In some embodiments, the line is displayed relative to representation of at least part of the environment (e.g. relative to a virtual environment). For example, where the first mobile devices is an AR headset, or handheld mobile device with AR implemented, the view through the AR headset or handheld mobile device may show the line representing the recommended travel path superimposed on a virtual environment viewable through the AR headset or handheld mobile device. Accordingly, the first user can play an AR game utilising the virtual environment whilst simultaneously being guided along the recommended travel path to, for example, avoid obstacles in the environment such as the second user or street furniture.

Embodiments according to the second aspect differ from the first aspect in that embodiments according to the second aspect do not require communication with/from the second mobile device for the first mobile device to determine the recommended travel path for the first user. Other than this, the description for the first aspect is applicable to the second aspect and vice-versa. For example, the description in respect of priority information, types of features, providing the indication of the recommended travel path, the minimum path length, and types of recommended travel path and the like apply equally to the second aspect. Furthermore, the first and second aspects may be combined. For example, as mentioned in the description for the first aspect, the determination of the location information of the second mobile device may comprise predicting a location of the second mobile device at a future time based on the communication with the second mobile device and based on the generated representation of at least part of the environment. Similarly, as mentioned in the description for the second aspect, the second mobile device may transmit an indication of a recommended route for the second user to the first mobile device (or vice versa) to facilitate path planning or updating.

### Example Implementations

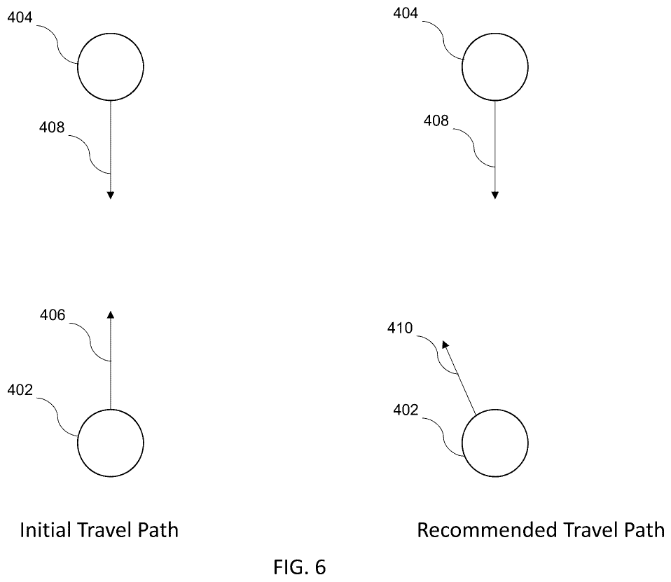

FIG. 6 schematically illustrates providing a recommended travel path for a user in accordance with example embodiments. FIG. 6 illustrates a first user 402 travelling along an initial travel path 406 for the first user 402 and a second user 404 travelling along an initial travel path 408 for the second user 404. Although not shown in FIG. 6 for simplicity, the first user 402 carries a first mobile device. The first mobile device may be a handheld mobile device or an AR headset, for example. Similarly, although not shown in FIG. 6 for simplicity, the second user 408 carries a second mobile device. The second mobile device may be a handheld mobile device or an AR headset, for example. The initial travel paths 406, 408 may be travel paths recommended to the first user 402 and second user 404 respectively via the first and second mobile devices respectively. Alternatively, the initial travel paths 406, 408 may be paths which the first user 402 and second user 404 have chosen to traverse of their own volition without recommendation.

In accordance with example embodiments, the first mobile device may wirelessly communicate with the second mobile device via radio signals and/or ultrasound signals to determine location information of the second mobile device. The first mobile device may determine, for example, that the first user 402 is on course to collide with the second user 404.

As shown in FIG. 6, the first mobile device determines a recommended travel path 410 for the first user 402 based on the location information of the second mobile device. In the example shown in FIG. 6, the recommended path 410 for the first user 402 is determined to avoid a collision with the second user 404. The recommended travel path 401 shown in FIG. 6 guides the user to move to veer towards the left to avoid collision with the second user 404.

The first mobile device provides an indication of the recommended travel path 410 to the first user 402. For example, a left side of the first mobile device may vibrate to indicate to the first user to veer left; the first mobile device may emit a sound saying: “Veer Left”; the sound being emitted from an application being run by the first mobile device may be emitted louder out of speakers/headphones on the left of the device compared with the right of the device; or the first mobile device may display an arrow indicating to the first user 402 to veer left.

Accordingly, example embodiments can avoid collisions between users of mobile devices in an energy efficient manner.

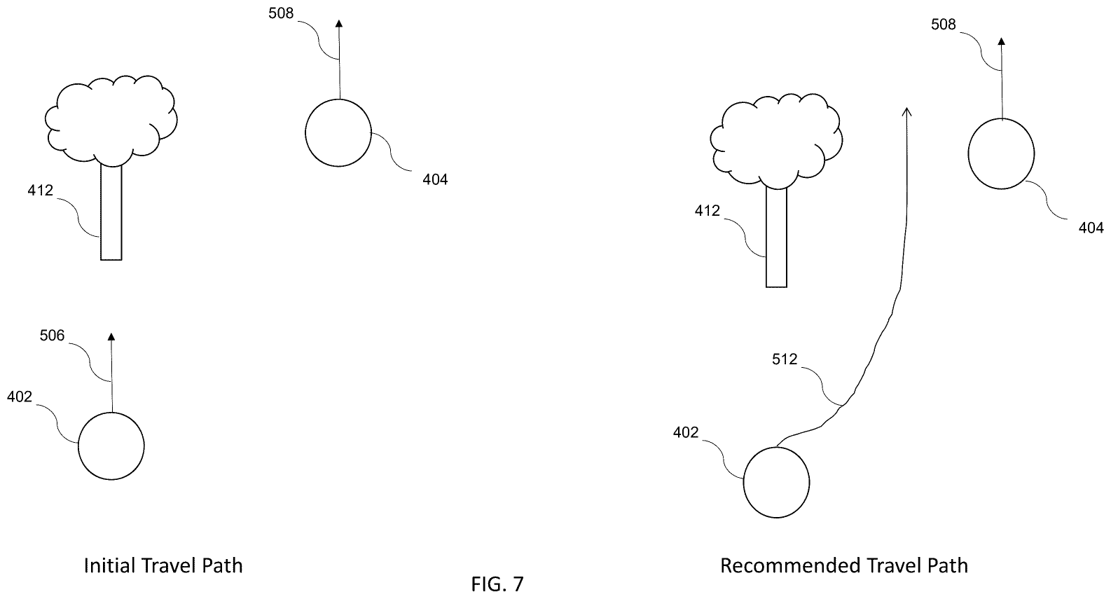

FIG. 7 schematically illustrates providing a recommended travel path for a user in accordance with example embodiments. FIG. 7 illustrates a first user 402 travelling along an initial travel path 506 for the first user 402 and a second user 404 travelling along an initial travel path 508 for the second user 404. Although not shown in FIG. 7 for simplicity, the first user 402 carries a first mobile device. The first mobile device may be a handheld mobile device or an AR headset, for example. Similarly, although not shown in FIG. 7 for simplicity, the second user 408 carries a second mobile device. The second mobile device may be a handheld mobile device or an AR headset, for example. The initial travel paths 506, 508 may be travel paths recommended to the first user 402 and second user 404 respectively via the first and second mobile devices respectively. Alternatively, the initial travel paths 506, 508 may be paths which the first user 402 and second user 404 have chosen to traverse of their own volition without recommendation. Also shown is an obstacle 412 (such as a tree) in the initial path 506 for the first user.

In accordance with example embodiments, the first mobile device may capture one or more images of an environment. The first mobile device then generates a representation of at least a part of the environment based on the one or more images. The representation of the at least part of the environment may include a representation of the obstacle 412 and the second user 404. The first mobile device may classify the obstacle 412 as static obstacle and classify the second user 404 as a dynamic obstacle. The first mobile device predicts a location of the obstacle 412 and the second user 404 (who is regarded as an obstacle in this example). For example, the first mobile device predicts that the obstacle 412 will be at the same location at the future time and the first mobile device predicts that the second user will be further along the path 508 at the future time.

Based on the predicted location of the obstacle 412 and the second user 508, the first mobile device determines a recommended travel path 512 for the first user 402. In this example, as shown in FIG. 7, the recommended travel path 512 is determined so as to avoid collision with the obstacle 412 and the second user 404.

The first mobile device provides an indication of the recommended travel path 512 to the first user 402. For example, the first mobile device may display the recommended travel path 512 relative to the environment. For example, where the first mobile devices is an AR headset, the view through the AR headset may show the obstacle 412 and the second user 404 and also a superimposed line representing the recommended travel path 512 to guide the first user 402 along the recommended travel path 512. In other words, the recommended travel path 512 is displayed in a virtual environment. Therefore, the recommended travel path 512 can be displayed while the first user 402 is playing an AR game on the first mobile device.

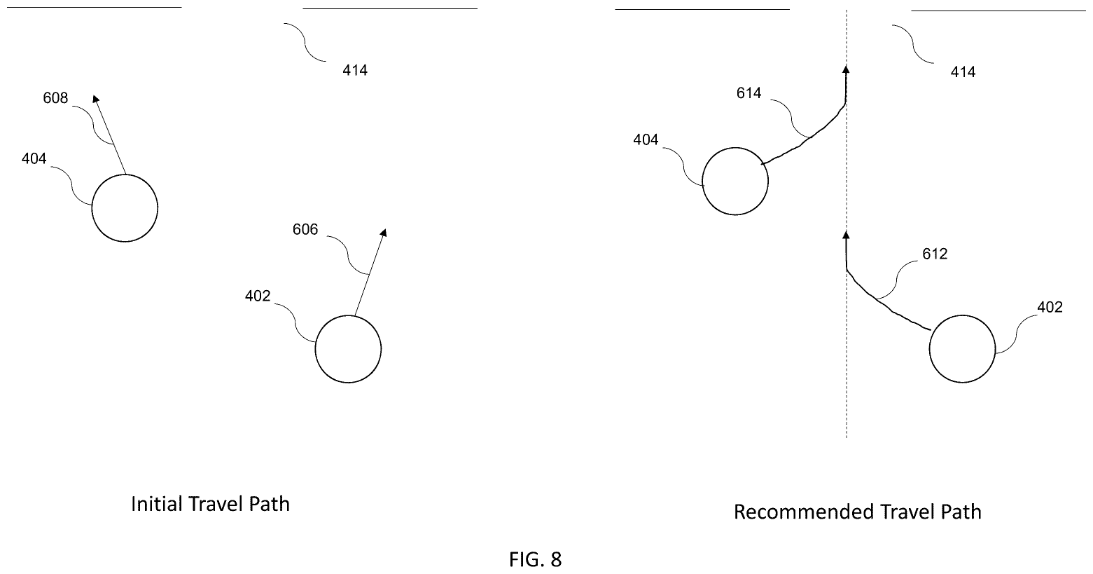

FIG. 8 schematically illustrates providing a recommended travel path for a user in accordance with example embodiments. FIG. 8 illustrates a first user 402 travelling along an initial travel path 606 for the first user 402 and a second user 404 travelling along an initial travel path 608 for the second user 404. Although not shown in FIG. 8 for simplicity, the first user 402 carries a first mobile device. The first mobile device may be a handheld mobile device or an AR headset, for example. Similarly, although not shown in FIG. 8 for simplicity, the second user 408 carries a second mobile device. The second mobile device may be a handheld mobile device or an AR headset, for example. The initial travel paths 606, 608 may be travel paths recommended to the first user 402 and second user 404 respectively via the first and second mobile devices respectively. Alternatively, the initial travel paths 606, 608 may be paths which the first user 402 and second user 404 have chosen to traverse of their own volition without recommendation. Also shown is a feature 414 of the environment which in this example is an exit which both the first user 404 and the second user 402 desire to leave through.

In accordance with example embodiments, the first mobile device may capture one or more images of an environment. The first mobile device then generates a representation of at least a part of the environment based on the one or more images. The representation of the at least part of the environment may include a representation of features of the environment such as the exit 414 and the second user 404. The first mobile device may classify the exit 414 as static obstacle and classify the second user 404 as dynamic. The first mobile device predicts a location of the exit 412 and the second user 404. For example, the first mobile device predicts that the exit 414 will be at the same location at the future time and the first mobile device predicts that the second user 404 will be further along the path 608 at the future time. However, in some embodiments, the second mobile device transmits an indication of a recommended path 614 for the second user 404 to the first mobile device. In such embodiments, the first mobile device can more accurately determine the predicted location of second mobile device because it can use the one or more of images of the second mobile device and/or the indication of the recommended travel path 614 received from the second mobile device. In such embodiments, the first mobile device may determine that the second mobile device will be along the recommended travel path 614 at the future time.

Based on the predicted location of the exit 414 and the second user 508, the first mobile device determines a recommended travel path 512 for the first user 402. In this example, as shown in FIG. 8, the recommended travel path 512 is determined so that the first user 402 is guided towards the exit 414 and also avoids collision with the second user 404 who is also being guided towards the exit 414.

The first mobile device provides an indication of the recommended travel path 612 to the first user 402. For example, the first mobile device may display the recommended travel path 612 relative to the environment. For example, where the first mobile devices is an AR headset, the view through the AR headset may show the exit 414 and the second user 404 and also a superimposed line representing the recommended travel path 612 to guide the first user 402 along the recommended travel path 612. In other words, the recommended travel path 612 is displayed in a virtual environment. Therefore, the recommended travel path 612 can be displayed while the first user 402 is playing an AR game on the first mobile device.

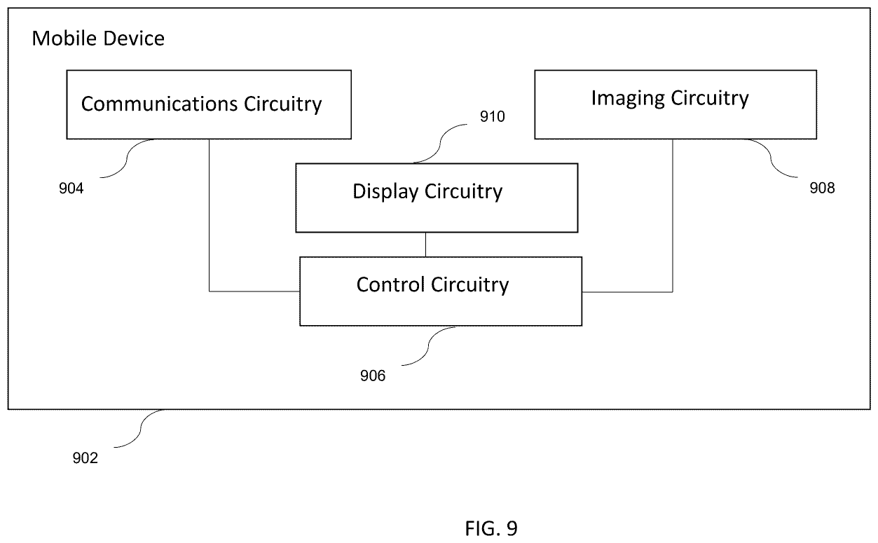

FIG. 9 schematically illustrates a first mobile device in accordance with example embodiments.

The mobile device 902 may comprise communications circuitry 904. The communications circuitry 904 is configured to transmit and receive wireless signals and may comprise, for example, transmitter circuitry and receiver circuitry, or transceiver circuitry. For example, the communications circuitry 904 may be configured to wirelessly communicate with the second mobile device.

The mobile device 902 may comprise imaging circuitry 908 configured to capture one or more images. For example, the imaging circuitry 908 may capture one or more images of an environment.

The mobile device 902 may comprise display circuitry 910 configured to display information on the mobile device 902, or output it to a companion device (e.g. in the case of a phone driving an HMD display). For example, the display circuity 910 may be configured to display, or output for display, the recommended travel path for the first user on the mobile device 902.

The mobile device 902 may comprise control circuitry 906 configured to control the components of the mobile device 902 including the communications circuitry 904, the imaging circuitry 908 and the display circuity 910. The control circuitry 906 comprise circuitry for one or more of: a Central processing unit (CPU), one or more microcontrollers, and/or one or microprocessors. The control circuitry 906 may be configured to retrieve instructions from a memory unit (not shown) of the mobile device 902 and execute those instructions to control operations of the mobile device 902. The control unit 406 is configured to control the components of the processing apparatus 402.

Although FIG. 9 has been described for the first mobile device, the second mobile device may also have the structure described with reference to FIG. 9. Similarly as described elsewhere herein, the or each mobile device may have the structure described with reference to FIG. 1, or any suitable combination of the features of FIGS. 1 and 9.

It will be appreciated that example embodiments can be implemented by computer software operating on a general purpose computing system. In these examples, computer software, which when executed by a computer, causes the computer to carry out any of the methods discussed above is considered as an embodiment of the present disclosure. Similarly, embodiments of the disclosure are provided by a non-transitory, machine-readable storage medium which stores such computer software.

It will also be apparent that numerous modifications and variations of the present disclosure are possible in light of the above teachings. It is therefore to be understood that within the scope of the appended claims, the disclosure may be practised otherwise than as specifically described herein.

Hence the foregoing discussion discloses and describes merely exemplary embodiments of the present invention. As will be understood by those skilled in the art, the present invention may be embodied in other specific forms without departing from the spirit or essential characteristics thereof. Accordingly, the disclosure of the present invention is intended to be illustrative, but not limiting of the scope of the invention, as well as other claims. The disclosure, including any readily discernible variants of the teachings herein, defines, in part, the scope of the foregoing claim terminology such that no inventive subject matter is dedicated to the public.

1. A method performed by a first mobile device for guiding travel of a first user of the first mobile device, the method comprising
wirelessly communicating with a second mobile device of a second user,
determining, based on the communication with the second mobile device, location information of the second mobile device,
determining, based on the location information of the second mobile device, a recommended travel path for the first user, and
providing an indication of the recommended travel path to the first user.

2. The method of claim 1, wherein the wirelessly communicating with the second mobile device comprises
wirelessly communicating with the second mobile device using radio signals.

3. The method of claim 1, wherein the wirelessly communicating with the second mobile device further comprises
wirelessly communicating with the second mobile device using ultrasound signals.

4. The method of claim 1, wherein the determining the location information of the second mobile device based on the communication with the second mobile device comprises
determining a distance between the first mobile device and the second mobile device based on the communication with the second mobile device, and
determining a direction in which the second user of the second mobile device is moving based on the communication with the second mobile device.

5. The method of claim 1, wherein the wirelessly communicating with the second mobile device comprises
receiving, from the second mobile device, an indication of a recommended travel path for the second user, wherein the recommended travel path for the first user is determined based at least in part on the indication of the recommended travel path for the second user.

6. The method of claim 5, wherein the recommend travel path for the first user converges with the recommended travel path for the second user.

7. The method of claim 1, wherein the providing the indication of the recommended travel path to the first user comprises performing one or more operations selected from the list consisting of:
i) vibrating a part of the first mobile device to indicate the recommended travel path,
ii) emitting a sound from the first mobile device to indicate the recommended travel path, and
iii) displaying the indication of the recommended travel path on the first mobile device.

8. The method of claim 1, wherein the location information of the second mobile device is determined based on the communication with the second mobile device and based on one or more images of an environment comprising the second mobile device captured by the first mobile device.

9. The method of claim 8, wherein the determining the recommended travel path for the first user comprises
determining, based on the one or more images, location information of one or more features in the environment other than the second user, and
determining the recommended travel path for the first user based on the location information of the second user and the location information of the one or more other features.

10. The method of claim 9, wherein the method comprises
generating, based on the one or more images, a representation of at least part of the environment, wherein
the determining the location information of the second mobile device comprises predicting a location of the second mobile device at a future time based on the communication with the second mobile device and based on the generated representation of at least part of the environment, and
the determining the location information of the one or more other features comprises predicting a location of the one or more other features at the future time based on the generated representation of at least part of the environment.

11. (canceled)

12. The method of claim 9, wherein the determining the recommended travel path for the first user comprises
identifying, based on the one or more images, one or more gaps between the second user and the one or more other features, and
routing the recommended travel path for the first user through one or more of the identified gaps.

13. (canceled)

14. (canceled)

15. The method of claim 1, wherein the recommended travel path guides the first user to avoid a collision between the first user and the second user.

16. The method of claim 1, wherein the recommend travel path guides the first user to reach the same location as the second user at a different time.

17. The method of claim 1, wherein the determining the recommended travel path for the first user comprises defining a minimum travel path length for the recommended travel path for the first user based on one or more conditions.

18. The method of claim 1, wherein the wirelessly communicating with the second mobile device of the second user comprises receiving priority determination information from the second mobile device, and the method comprises
determining, based on the priority determination information, that the recommended travel path for the first user has a higher priority than a recommended travel path for the second user, and
transmitting a priority indication to the second mobile device indicating that that the recommended travel path for the first user has a higher priority than the recommended travel path for the second user, the priority indication indicating to the second mobile device to adjust the recommended travel path for the second user.

19. The method of claim 18, wherein the priority determination information comprises one or more selected from the list consisting of:
i) an indication of a speed of movement of the second mobile device; and
ii) an indication of a number of features the recommended travel path for the second user has been routed to avoid.

20. A method performed by a first mobile device for guiding travel of a first user of the first mobile device, the method comprising
capturing one or more images of an environment,
generating, based on the one or more images of the environment, a representation of at least part of the environment,
predicting a location of one or more features in the environment at a future time based on the generated representation of at least part of the environment,
determining a recommended travel path for the first user based on the predicted location of the one or more features, and
providing an indication of the recommended travel path to the first user.

21. (canceled)

22. The method of claim 20, wherein the method comprises
receiving, from a second mobile device of a second user, an indication of a recommended travel path for the second user, and
adjusting the recommended travel path for the first user based on the indication of the recommended travel path for the second user.

23. The method of claim 22, wherein the adjusting the recommended travel path for the first user based on the indication of the travel path for the second user comprises adjusting the recommended travel path for the first user to avoid a collision with the second user.

24. A first mobile device for guiding travel of a first user of the first mobile device, the first mobile device comprising circuitry configured to
wirelessly communicate with a second mobile device of a second user,
determine, based on the communication with the second mobile device, location information of the second mobile device,
determine, based on the location information of the second mobile device, a recommended travel path for the first user, and
provide an indication of the recommended travel path to the first user.

25. (canceled)
